(19) United States
(12) Patent Application Publication
(10) Pub. No.: US 2021/0022417 A1
(43) Pub. Date: Jan. 28, 2021

(54) STRUTTING PIECE FOR MASKS

(71) Applicant: HUI-YU CHANG, TAIPEI (TW)

(72) Inventor: HUI-YU CHANG, TAIPEI (TW)

(21) Appl. No.: 16/882,620

(22) Filed: May 25, 2020

(30) Foreign Application Priority Data
Jul. 25, 2019 (TW) 108209758

(51) Int. Cl. A41D 13/11

(52) U.S. Cl. CPC A41D 13/1138; A41D 13/1161

(57) ABSTRACT

The present invention provides a strutting piece for masks, comprising an approximately convex shell-like supporter and a sealing element. The supporter comprises a ring frame and a shell part connected to one side of ring frame. The shell part is apart from the mouth and nose at a proper distance, and its outside is covered with the mask. The sealing element is arranged outside the ring frame to contact the face tightly and maintain the leakproofness of wearing mask. Thereby, it can mantle the mouth and nose with its outside covered with a planar mask.

### BACKGROUND OF INVENTION

### 1. Field of the Invention

The present invention relates generally to masks, and more particularly to a strutting piece for masks.

### 2. Description of Related Art

The conventional masks are divided into planar and 3D forms. The planar mask is made by laminating filtering materials as nonwoven fabric or sewing other fabrics, it covers the mouth and nose directly. The 3D mask mantles the mouth and nose without contacting the mouth and nose.

In terms of the comfort of use, the 3D mask not contacting mouth and nose is better, but the planar mask has larger consumption than the 3D mask for lower manufacturing cost. However, the user's saliva will be sprayed onto the mask, infecting the mouth and nose again. If a female rouged is to wear a mask, the planar mask covering the mouth and nose directly will certainly contact the rouge, the rouge will be ruined, the planar mask is inapplicable, whereas the 3D mask will not have this problem.

Therefore, in order to solve the defects in said planar mask and 3D mask, the inventor invented the strutting piece for masks based on years' spirit of innovative research and development.

### SUMMARY OF THE INVENTION

The primary object of the present invention is to provide a strutting piece for masks, which can be used for strutting a planar mask to avoid the mask contacting the mouth and nose, a space for smooth breathing is formed, and the lip rouge will not be ruined by contact, the comfortable sensation of planar mask can be enhanced, the utility of 3D mask is generated, and it can be used for another planar mask without change, it has use value.

Therefore, in order to attain the aforesaid purpose, the present invention provides a strutting piece for masks, which mantles the mouth and nose, and it is covered with the mask, comprising a supporter, approximately a convex shell, including a ring frame and a shell part connected to one side of ring frame, the shell part is apart from the mouth and nose at a proper distance, and its outside is covered with the mask; a sealing element, arranged outside the ring frame to contact the face closely and maintain the leakproofness of wearing mask.

### DETAILED DESCRIPTION OF THE INVENTION

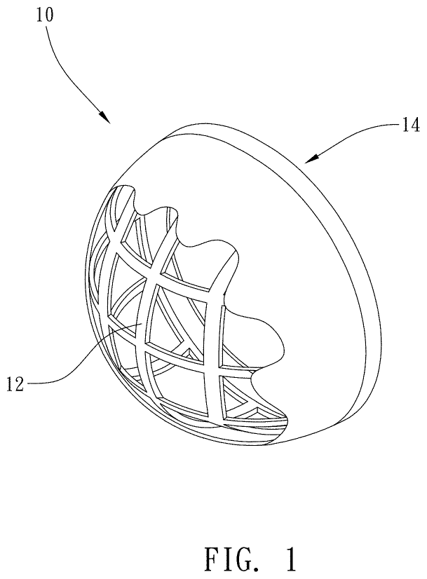

FIG. 1 is the stereogram of a preferred embodiment of the present invention.

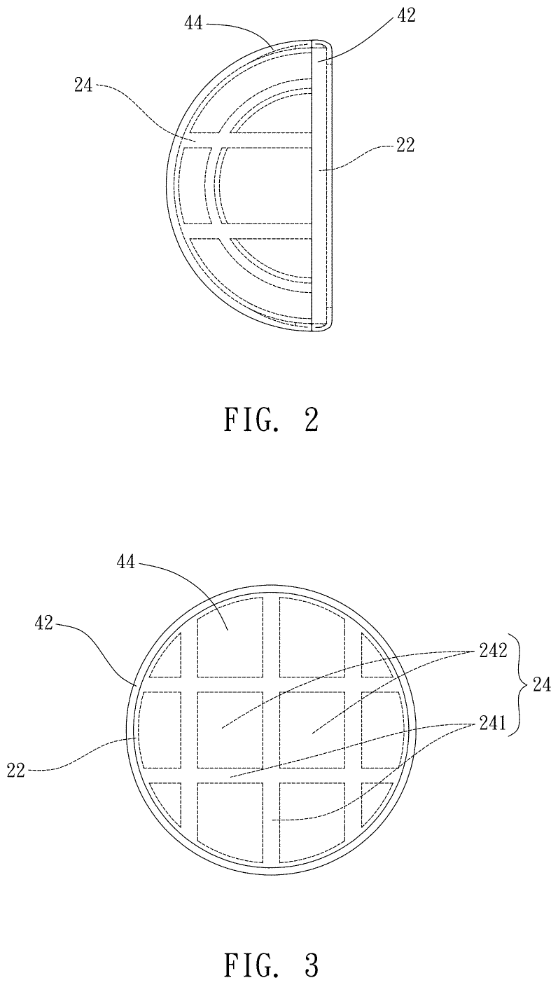

FIG. 2 is the side view of a preferred embodiment of the present invention.

FIG. 3 is the rear view of a preferred embodiment of the present invention.

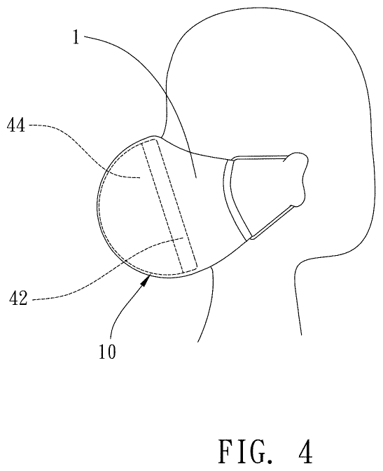

FIG. 4 is the service mode diagram of a preferred embodiment of the present invention.

### DETAILED DESCRIPTION OF THE INVENTION

Several preferred embodiments of the present invention are described in detail with figures below.

First of all, as shown in FIG. 1 to FIG. 3, the mask strutting piece 10 of a preferred embodiment of the present invention comprises a supporter 12 and a sealing element 14.

The supporter 12 is made of an elastic material like plastics, approximately a convex shell, comprising a ring frame 22 and an integrated shell part 24 connected to one side of ring frame 22. The shell part 24 comprises a plurality of support bars 241 connected up, and a plurality of through holes 242 are formed among the support bars 241, the through holes 242 are provided for aeration.

The sealing element 14 is made of a material with appropriate softness as silica gel or fabric, comprising a contacting part 42 and an extension part 44. The contacting part 42 is disposed outside the ring frame 22 for contacting the face tightly. The extension part 44 extends from one side of contacting part 42 to the shell part 24 to shield the shell part 24.

Thereby, the mask strutting piece 10 of the present invention is a fitting for wearing a mask, the usage mode, characteristics and effect are described below.

As shown in FIG. 4, when the user wears a known planar mask 1, the strutting piece 10 can be put close to the face with the sealing element 14 and located between the mask 1 and mouth and nose, and the edge of the mask 1 covers the extension part 42, thus, the mask 1 will not cling to the user's mouth and nose directly under the strutting effect of the strutting piece 10, forming the utility of the known 3D mask, the comfortable sensation of the planar mask 1 can be enhanced, and the user's saliva will not be sprayed onto the mask to avoid infecting the mouth and nose again.

Secondly, the strutting piece 10 clings to the face through the contacting part 42, and the edge of the mask 1 covers the extension part 42, so the leakproofness of wearing the mask 1 can be maintained. Moreover, the top side of the extension part 44 can protrude upward for a proper length, when a person wearing glasses wears a mask using the strutting piece 10, the glasses can press the extension part 44, so as to help fix the strutting piece 10.

Furthermore, even if the mask 1 is discarded after use, the strutting piece 10 is still applicable to any mouth and nose veil as a new planar mask (e.g. windproof and coldproof head cover or bicycle mask).

Therefore, the strutting piece provided by the present invention can support the planar mask, generating the effect of 3D mask not covering the mouth and nose, the comfortable sensation of planar mask is enhanced, the user's saliva will not be sprayed onto the mask to infect the mouth and nose again, and the lip rouge will not be ruined by contact. It has good airtightness, and can be reused after cleaning. It can also be used with new planar masks, it has significant use value.

What is claimed is:

1. A strutting piece for masks, which can mantle the mouth and nose, and it is covered with mask, comprising:
a supporter, approximately a convex shell, comprising a ring frame and a shell part connected to one side of ring frame, the shell part is apart from the mouth and nose at an appropriate distance, and it is covered with mask; and
a sealing element, arranged outside the ring frame, for contacting the face tightly and maintaining the leakproofness of wearing mask.

2. The strutting piece for masks defined in claim 1, wherein the shell part is composed of a plurality of support bars connected up, and a plurality of through holes are formed among the support bars.

3. The strutting piece for masks defined in claim 1, wherein the sealing element has appropriate softness, comprising a contacting part and an extension part, the contacting part is disposed outside the ring frame for contacting the face tightly, the extension part extends from one side of contacting part to the shell part to shield partial or full shell part, so that the edge of mask can cover the extension part.

4. The strutting piece for masks defined in claim 2, wherein the sealing element has appropriate softness, comprising a contacting part and an extension part, the contacting part is disposed outside the ring frame for contacting the face tightly, the extension part extends from one side of contacting part to the shell part to shield partial or full shell part, so that the edge of mask can cover the extension part.
